(19) United States
(12) Patent Application Publication
(10) Pub. No.: US 2017/0018270 A1
(43) Pub. Date: Jan. 19, 2017

(54) SPEECH RECOGNITION APPARATUS AND METHOD

(71) Applicant: Samsung Electronics Co., Ltd., Suwon-si (KR)

(72) Inventor: Yun Hong MIN, Seoul (KR)

(73) Assignee: Samsung Electronics Co., Ltd., Suwon-si (KR)

(21) Appl. No.: 15/147,965

(22) Filed: May 6, 2016

(30) Foreign Application Priority Data
Jul. 16, 2015 (KR) 10-2015-0101201

(51) Int. Cl. G10L 15/16; G10L 15/02; G10L 13/02; G10L 15/06; G10L 15/14; G10L 15/18

(52) U.S. Cl. CPC G10L 15/16; G10L 15/142; G10L 15/18; G10L 13/02; G10L 15/063; G10L 15/02; G10L 15/22

(57) ABSTRACT

A speech recognition apparatus includes a converter configured to convert a captured user speech signal into a standardized speech signal format, one or more processing devices configured to apply the standardized speech signal to an acoustic model, and recognize the user speech signal based on a result of application to the acoustic model.

### CROSS-REFERENCE TO RELATED APPLICATION(S)

This application claims the benefit under 35 USC 119(a) of Korean Patent Application No. 10-2015-0101201, filed on Jul. 16, 2015 in the Korean Intellectual Property Office, the entire disclosure of which is incorporated herein by reference for all purposes.

### BACKGROUND

1. Field

The following description relates to a speech recognition technology.

2. Description of Related Art

Training data used by an apparatus in learning an acoustic model is usually gathered from numerous people and their speech patterns, which vary greatly depending on a number of factors, such as voice, age, gender, and intonation. Because the aforementioned data is general in its attributes, a separate process has heretofore been beneficial when attempting to improve an apparatus's speech recognition accuracy regarding a particular individual.

An example of such existing approach is one in which an apparatus learns an acoustic model that was created based on various speech data collected from numerous people, and then re-learns the acoustic model after it has been adjusted to reflect the speech characteristics of a particular individual. Another example approach is one in which an individual's speech data is converted into a specific data format, and the format of data is input to an existing acoustic model.

In the aforesaid approaches, apparatuses are trained in general acoustic models that were created based on human speech, and so, when the speech characteristics of an individual have to be reflected in a model, larger quantities of training data have heretofore been required. For example, speech data from several tens to tens of thousands of people may be required. Moreover, in order to improve the speech recognition rate, sample selection for training and the size of samples may be considered, though even after such sample selection, there may still be enormous cost for collecting data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a speech recognition apparatus includes a converter configured to convert a captured user speech signal into a standardized speech signal format; one or more processing devices configured to apply the standardized speech signal to an acoustic model; and to recognize the user speech signal based on a result of application to the acoustic model.

A format of the standardized speech signal may include a format of a speech signal that is generated using text-to-speech (TTS).

The converter may include at least one of the following neural network models: autoencoder, deep autoencoder, denoising autoencoder, recurrent autoencoder, and a restricted Boltzmann machine (RBM).

The converter may be further configured to segment the user speech signal into a plurality of frames, extract k-dimensional feature vectors from each of the frames, and convert the extracted feature vectors into a format of the standardized speech signal format.

The standardized speech signal format may include at least one form of a mel-scale frequency cepstral coefficient (MFCC) feature vector and a filter bank, and may contain either or both of the number of frames and information regarding a dimension.

The acoustic model may be based on at least one of Gaussian mixture model (GMM), hidden Markov model (HMM), and a neural network (NN).

The speech recognition apparatus may further include a training data collector configured to collect training data based on a synthetically generated standardized speech signal; a trainer configured to train at least one of the converter or the acoustic model using the training data; and a model builder configured to build the acoustic model based on a result of training based on the standardized speech signal.

According to another general aspect, a speech recognition apparatus includes a training data collector configured to collect training data based on a generated standardized speech signal; a trainer configured to train at least one of a converter or an acoustic model using the training data; and a model builder configured to build at least one of the converter or the acoustic model based on a result of training.

The standardized speech signal includes either or both of a speech signal that is generated using text-to-speech (TTS) and a speech signal that is converted from the user speech signal using the converter.

The training data collector may be further configured to generate a synthesized speech by analyzing an electronic dictionary and grammatical rules by use of the TTS.

The training data collector may be further configured to collect a standardized speech signal that substantially corresponds to the user speech signal, as the training data.

The standardized speech signal that substantially corresponds to the user speech signal may be a speech signal generated from a substantially same text as represented in the user speech signal, by use of TTS.

The training data collector may be further configured to receive feedback from a user regarding a sentence, which is produced based on a speech recognition result, and to collect a standardized speech signal generated from the feedback by the user, as the training data.

The converter may include at least one of the following neural network models: autoencoder, deep autoencoder, denoising autoencoder, recurrent autoencoder, and a restricted Boltzmann machine (RBM).

The trainer may be further configured to train the converter such that a distance between a feature vector of the user speech signal and a feature vector of the standardized speech signal can be minimized.

The trainer may be further configured to calculate the distance between the feature vectors based on at least one of distance calculation methods including a Euclidean distance method.

The acoustic model may be at least one of Gaussian mixture model (GMM), hidden Markov model (HMM), and a neural network (NN).

The speech recognition apparatus may further include a converter configured to convert a collected user speech signal into the standardized speech signal; an acoustic model applier configured to apply the standardized speech signal to the acoustic model; and an interpreter configured to recognize the user speech signal based on a result of application to the acoustic model.

According to another general aspect, a speech recognition method, includes converting a user speech signal into a format of standardized speech signal; applying the standardized speech signal to an acoustic model; and recognizing the user speech signal based on a result of application to the acoustic model.

The converting may be based on at least one of the following neural network models: autoencoder, deep autoencoder, denoising autoencoder, recurrent autoencoder, and a restricted Boltzmann machine (RBM).

The converting of the user speech signal may include segmenting the user speech signal into a plurality of frames, extracting k-dimensional feature vectors from each of the frames, and converting the extracted feature vectors into a format of the standard speech signal.

The format of the standard speech signal may include at least one form of a mel-scale frequency cepstral coefficient (MFCC) feature vector and a filter bank and contains either or both the number of frames and information regarding a dimension.

According to another general aspect, a speech recognition method, includes receiving a user speech sample of a training phrase; generating a synthesized baseline speech sample of the training phrase; transforming one or more of the user speech sample and the baseline speech sample into a standardized format for provision to a speech model; and, generating the speech model for the user based on the comparison of the user speech sample and the baseline speech sample.

The speech recognition method may further include actuating a microphone and a processor portion to record the user speech sample; and, actuating the processor portion to execute a text-to-speech (TTS) engine to generate the baseline speech sample of the training phrase.

The speech recognition method may further include actuating a microphone and a processor portion to record user speech; and, actuating the processor portion to recognize the user speech based on the generated speech model.

The speech recognition method may further include controlling an electronic device based on the recognized user's speech.

Other features and aspects will be apparent from the following detailed description, the drawings, and the claims.

### BRIEF DESCRIPTION OF THE DRAWINGS

FIG. 1 is a block diagram illustrating an example of a speech recognition apparatus according to one or more embodiments.

FIG. 2 is a block diagram illustrating a modeling apparatus for speech recognition according to one or more embodiments.

FIG. 3 is a diagram explaining a relationship between a converter and a standard acoustic model according to one or more embodiments.

FIG. 4 is a diagram illustrating an example of a setting of parameters of a converter using a modeling apparatus for speech recognition according to one or more embodiments.

FIG. 5 is a flowchart illustrating a speech recognition method according to one or more embodiments.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, after an understanding of the present disclosure, various changes, modifications, and equivalents of the methods, apparatuses, and/or systems described herein may then be apparent to one of ordinary skill in the art. The sequences of operations described herein are merely non-limiting examples, and are not limited to those set forth herein, but may be changed as will be apparent to one of ordinary skill in the art, with the exception of operations necessarily occurring in a certain order, after an understanding of the present disclosure. Also, descriptions of functions and constructions that may be understood, after an understanding of differing aspects of the present disclosure, may be omitted in some descriptions for increased clarity and conciseness.

Various alterations and modifications may be made to embodiments, some of which will be illustrated in detail in the drawings and detailed description. However, it should be understood that these embodiments are not construed as limited to the disclosure and illustrated forms and should be understood to include all changes, equivalents, and alternatives within the idea and the technical scope of this disclosure.

Terms used herein are to merely explain specific embodiments, thus they are not meant to be limiting. A singular expression includes a plural expression except when two expressions are contextually different from each other. For example, as used herein, the singular forms “a”, “an”, and “the” are intended to include the plural forms as well, unless the context clearly indicates otherwise. Herein, a term “include” or “have” are also intended to indicate that characteristics, figures, operations, components, or elements disclosed on the specification or combinations thereof exist. The term “include” or “have” should be understood so as not to pre-exclude existence of one or more other characteristics, figures, operations, components, elements or combinations thereof or additional possibility. In addition, though terms such as first, second, A, B, (a), (b), and the like may be used herein to describe components, unless indicated otherwise, these terminologies are not used to define an essence, order, or sequence of a corresponding component but used merely to distinguish the corresponding component from other component(s). Furthermore, any recitation of ranges of values herein are merely intended to serve as a shorthand method of referring individually to each separate value falling within the range, unless otherwise indicated herein, and each separate value is incorporated into the specification as if it were individually recited herein.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

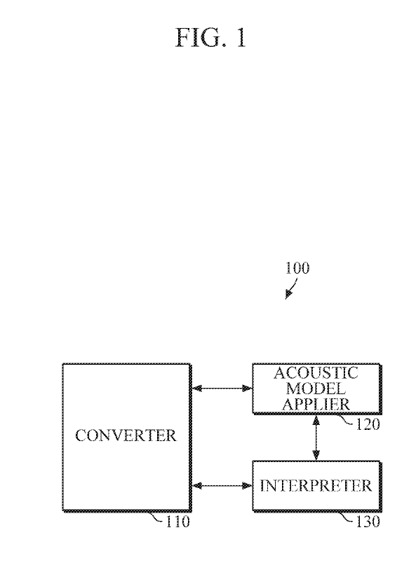

FIG. 1 is a block diagram illustrating a speech recognition apparatus according to one or more embodiments. The speech recognition apparatus 100 includes a converter 110, an acoustic model applier 120, and an interpreter 130, for example.

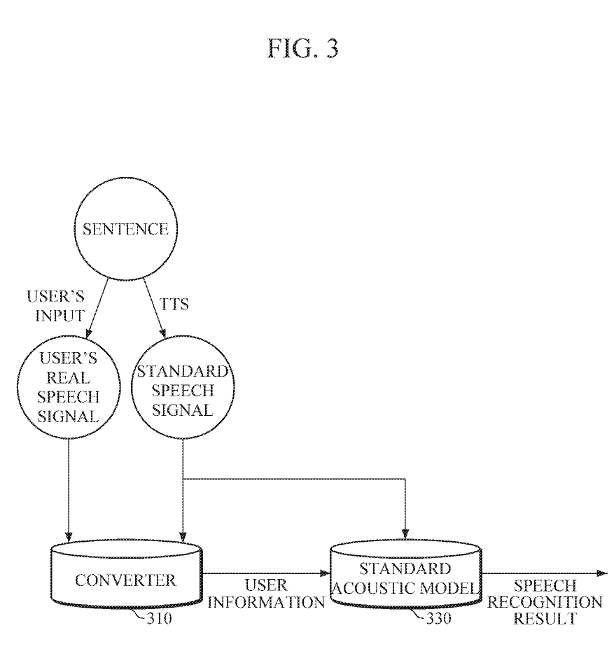

The apparatuses, units, modules, devices, and other components (e.g., converter 110/310, acoustic model applier 120, interpreter 130, training data collector 210, trainer 220, model builder 230, standard acoustic model 330) illustrated in FIGS. 1-3 that may perform the operations described herein with respect to any of FIGS. 3-5, are for example, hardware components. Examples of hardware components include controllers, sensors, generators, drivers, processor portions, data storage devices, microphones, cameras, and the like, and any other electronic components known to one of ordinary skill in the art after gaining an understanding of the present disclosure. In one or more embodiments, the hardware components are implemented by one or more processing devices such as processors or computers. Such a processing device, processor, or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one or more embodiments, such a processor or computer includes, or is connected to, one or more memories storing instructions or software that are executed by the processor or computer. Hardware components implemented by a processor or computer execute instructions or software, such as an operating system (OS) and one or more software applications that run on the OS, to perform any of operations described herein with respect to FIGS. 3-5. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one or more embodiments, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The converter 110 converts an actual or captured user's speech signal into a format of a standard speech signal. The standard speech signal may be in the format of a speech signal generated using Text-to-Speech (TTS) technology, for example, or other synthetically generated speech signal, or in a format that subsequent device elements are compatible with, such as in a format the acoustic model applier or corresponding acoustic model is compatible with. In one or more embodiments, the standard speech signal format may be a format such that the characteristics or features of the user's speech signal may be compared with characteristics or features of a synthetically generated speech signal. The converter 110 may be trained in advance by a designated process that matches a previous actual, as captured, speech signal with a TTS speech signal for the same script represented by as the actual speech signal. The converter 110 includes one or more of neural network models including, as an example: autoencoder, deep autoencoder, denoising autoencoder, recurrent autoencoder, and a restricted Boltzmann machine (RBM). The converter 110 may include one or more microphone(s), noise reduction circuitry, memory storing any of such models or algorithms, and/or processing device(s) configured to implement the same.

In one or more embodiments, the converter 110 may segment the input user speech signal into a plurality of frames, extract k-dimensional feature vectors from each frame, and convert a format of each extracted feature vector into a standard speech signal format. The extracted feature vectors may be mel-scale frequency cepstral coefficient (MFCC) feature vectors or feature vectors in a filter bank. As there may be various suitable technologies for extracting feature vectors as would be known to one of skill in the art after an understanding of the present disclosure, a variety of feature vector extraction algorithms may be used in addition to, or in place of, the above example.

For example, the converter 110 may segment the user speech signal into a plurality of frames, and extract, for each frame, k-dimensional MFCC feature vectors from the mel-scale spectrum that are related to a detected frequency or an actually measured frequency.

The converter 110 may, for example, segment an input speech signal into 100 frames, and extract 12-dimensional (12^{th}-order coefficient) MFCC features. If a user speech signal is input for about 5 seconds, e.g. through a microphone of converter 110 or from a previously captured speech signal, the converter 110 segments the user speech signal into, as an example, 500 frames, and extracts, as an example, 12-dimensional feature vectors from each frame.

As another example, a user may read a sentence in 4 seconds that would typically have a standard speech signal length of 5 seconds. In this case, the converter 110 may convert the standard speech signal into 500 frames, as well as convert the corresponding captured user speech signal into 400 frames. That is, due to the user's language habits and user's unique characteristics, formats of feature vectors extracted from both the user speech signal and the standard speech signal may differ from each other.

The converter 110 may convert the feature vector extracted from the user speech signal into a standard speech signal format, thereby converting the user speech signal into a standard speech signal to be applied to a standard acoustic model. The standard speech signal format may be in the form of e.g. a mel-scale frequency cepstral coefficient (MFCC) feature vector, a filter bank, or other suitable measures, and may contain the number of frames and information regarding the dimension. For example, under the assumption that MFCC features are extracted, the format of feature vectors may have k-dimension (e.g., k is 12, 13, 26, 39, or the like). In addition, 40- or higher-dimension filter bank features may be extracted. The format of feature vectors may be designed to contain a time difference and a difference of time difference. The time difference may be v₍ₜ₎−v₍ₜ₋₁₎, and the difference of time difference may be expressed as (v₍ₜ₊₁₎−v₍ₜ₎)−(v₍ₜ₎−v₍ₜ₋₁₎). In this case, the dimension of features may be increased by multiple times.

As the format of feature vectors may vary, the detailed description of the format of feature vectors should not be limited to the above examples. Rather, any suitable format of feature vectors may be applied as would be known to one of skill in the art after a thorough understanding of the present disclosure.

The acoustic model applier 120 applies the user speech signal which has been converted into a standard speech signal format to a standard acoustic model. In this case, the standard acoustic model may be based on at least one of e.g. Gaussian mixture model (GMM), hidden Markov model (HMM), and a neural network (NN), or other suitable acoustic model. The acoustic model applier 120 may include a memory storing any such models, algorithms, or temporary work-files, and/or processing device(s) configured to implement the same.

The standard acoustic model may be a targeted standard acoustic model that has been trained beforehand to reflect the feature information of the user. If the apparatus has learned the targeted standard acoustic model well enough to sufficiently reflect the user's characteristic information, speech recognition rate and accuracy may be increased. As reflecting the user's language habits, intonation, tone of speech, frequently used words, and usage of dialect, the targeted standard acoustic model may be customized and optimized for each user.

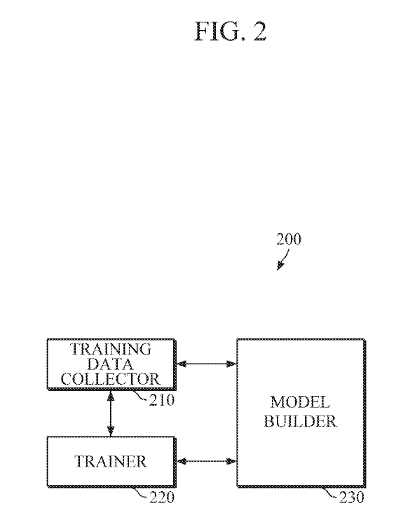

The interpreter 130 recognizes the user speech signal based on the result of application to the standard acoustic model. The interpreter 130 may include a memory storing any such models, algorithms, or temporary work-files, and/or processing device(s) configured to implement the same. In addition, in one or more embodiments, the converter 110, acoustic model applier 120, and/or interpreter 130 may be combined in any manner that includes a memory that stores the model(s) or algorithm(s) of converter 110 and the acoustic model of the acoustic model applier 120, and/or a processing device configured to implement the same. The recognition result of the interpreter 130 may be provided as training data to train the standard acoustic model targeted to the user, such as the training data of FIG. 2. Hereinafter, a modeling apparatus for speech recognition that establishes a targeted standard acoustic model is described.

FIG. 2 is a block diagram illustrating a speech recognition modeling apparatus according to one or more embodiments. The modeling apparatus 200 for speech recognition, in this example, includes a training data collector 210, a trainer 220, and a model builder 230.

The training data collector 210 collects training data based on a standard speech signal. Here, the standard speech signal may be a speech signal that is generated using text-to-speech (TTS). For example, the training data collector 210 may collect text, such as sentences and script, convert the text into synthesized speech or machine speech by analyzing electronic dictionaries and grammatical rules, and collect the converted speech as training data. In addition, when the user speech signal input is converted into a standard speech signal format by a converter, the training data collector 210 may collect the resulting standard speech signal as training data.

By using a standard speech signal as training data, it is helpful in building an acoustic model that can be standardized regardless of the user's gender, accent, tone, intonation, and overall idiolect. Also, it is beneficial in reducing the time and costs taken to collect data. Moreover, in one or more embodiments, the training data collector 210 collects documented data as training data, so that academic materials, names, and the like, which are not usually used in a daily language environment, can be collected as training data.

Generally, an acoustic model is created based on real human speech. Heretofore, if a language of the acoustic model is changed, an acoustic model created using a specific language could not be used for the changed language. However, according to one or more embodiments, the training data collector 210 collects sentences or text, and creates a speech signal by translating the collected sentence in conjunction with a text translation technique, so that procedures for collecting sample data and transforming the acoustic model according to the change of language may be simplified.

Also, the training data collector 210 may standardize the acoustic model using standard speech signals as training data. The standardized acoustic model has versatility and compatibility and can considerably reduce the computation quantity.

In another example, the training data collector 210 may generate one or more versions of a standard speech signal for each sentence by varying a TTS version, wherein the various versions of a standard speech signal are different from each other in terms of the speaker's gender and idiolect, such as accent, tone, and use of dialect. In other words, different TTS products from different vendors; different versions thereof; or by actuating different settings (e.g. speaker, origin, gender, tempo, or the like) of one or more TTS products, may be employed to generate several versions of the standard speech signal.

The training data collector 210 may collect human speech signals from individual speakers, as well as the standard speech signal. In one or more embodiments, the modeling apparatus 200 for speech recognition may design the standard acoustic model to be compatible with one or more existing models.

According to one or more embodiments, the training data collector 210 may collect the user speech signals and the standard speech signals that correspond to the user speech signals, as training data. The standard speech signal that corresponds to a user speech signal may be a speech signal that is generated by performing TTS on the same text that the user speech signal is generated from. For example, the training data collector 210 may provide a sentence or script to a user and capture, such as through a microphone (represented by the training data collector 210), or receive a real speech signal from the user; meanwhile, the training data collector 210 may also collect standard speech signals that are generated by performing TTS on the same sentence or script.

According to one or more embodiments, the training data collector 210 may receive feedback from the user regarding a sentence which is generated based on the speech recognition result, such as by the interpreter 130 of FIG. 1, and then the training data collector 210 may collect a standard speech signal that is generated based on from the feedback about the speech for the sentence, as training data. For example, the training data collector 210 may provide the user with the sentence for which the speech recognition result from the speech recognition apparatus 100 is based. The user may be queried to confirm the correct speech recognition result, or select any incorrectly recognized part in the recognition result and input the corrected part to the training data collector 210. For example, the user may speak the correction part. The modeling apparatus 200 for speech recognition may generate a standard speech signal based on the feedback sentence and use the newly generated standard speech signal as training data, thereby creating a targeted standard acoustic model and increasing the speech recognition rate.

Heretofore, typical standard speech signals for training typical standard acoustic models may have employed large-scale training data, whereas the standard speech signal in accordance with one or more embodiments for training the converter may employ only a portion of the typical training data of the typical standard acoustic model inasmuch as the standard speech signal of one or more embodiments is employed only for the purpose of obtaining feature information, as an example.

The trainer 220 may train the converter and the standard acoustic model using the training data. Further, according to one or more embodiments, the converter may include one of neural network models or a deep learning versions thereof, the neural network models including, for example, autoencoder, deep autoencoder, denoising autoencoder, recurrent autoencoder, and RBM. In addition, the standard acoustic model may be based on at least one of GMM, hidden Markov model HMM, and an NN.

According to one or more embodiments, the trainer 220 may train a converter based on the user speech signal among the training data and the standard speech signal that corresponds to said user speech signal. For example, the trainer 220 may segment the user speech signal into a plurality of frames and extract k-dimensional feature vectors from each frame. The trainer 220 may convert the extracted feature vectors of the user speech signal into a specific feature vector format of the standard speech signal. The trainer 220 may match the converted feature vectors of the user speech signal with the feature vectors of the standard speech signal that corresponds to said user speech signal, thereby training the converter. The extracted feature vectors may be in the form of a mel-scale frequency cepstral coefficient (MFCC) feature vector, a filter bank, or other suitable measure for maintaining the extracted feature vectors as would be apparent to one of skill in the art after gaining a thorough understanding of the present disclosure.

The format of the extracted feature vector may include a time difference and a difference of time difference. Here, the time difference may be v₍ₜ₎−v₍ₜ₋₁₎, and the difference of time difference may be expressed as (v₍ₜ₊₁₎−v₍ₜ₎)−(v₍ₜ₎−v₍ₜ₋₁₎). In this case, the dimension of features may be increased by multiples. For example, if a 13-dimensional MFCC feature vector includes information about a time difference, the 13-dimensional MFCC feature vector may be converted to become a 39-dimensional feature vector. In the same manner, if a 41-dimensional filter bank includes information about a time difference, the 41-dimensional filter bank feature vector in the filter bank may be converted to become a 123-dimensional feature vector.

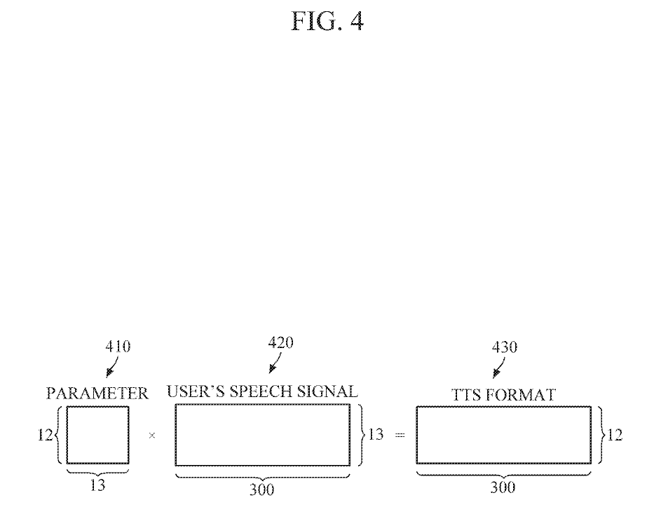

According to one or more embodiments, the trainer 220 may define a distance between a feature vector of the user speech signal and a feature vector of the standard speech signal that corresponds to said user speech signal, and the trainer 220 may set a parameter that minimizes the defined distance between the feature vectors as a substantially optimal parameter, thereby training the converter. In this case, the trainer 220 may calculate a distance between the feature vectors using one or any combination of differing distance calculation methods including, for example, Euclidean distance. In addition to the above example, other measures or approaches for calculating the distance between vectors may also be used, which will be described further below with reference to FIG. 4. The trainer 220 may train the converter and, provide the standard acoustic model with the user's feature information resulting from the training.

According to one or more embodiments, the model builder 230 builds a conversion model or conversion algorithm/parameters for a converter which may also be used by converter 110 of FIG. 1, and a standard acoustic model based on the training result from the trainer 220. According to one or more embodiments, the model builder 230 may build a targeted standard acoustic model by reflecting the user's feature information input from the converter. At this time, the standard acoustic model may be targeted to an individual user, or targeted to a target domain or a specific group of users.

Once the standard acoustic model is built, it is possible to reduce the time and costs taken to train the standard acoustic model. For example, according to one or more embodiments, it is possible to reduce resources required for speech data collection, development, and maintenance of the speech recognition engine. In addition, it is possible to build a personalized or targeted standard acoustic model by training a relatively small sized converter, and the targeted standard acoustic model may increase the accuracy of the speech recognition engine.

FIG. 3 is a diagram explaining a relationship between a converter and a standard acoustic model according to one or more embodiments. For convenience of explanation, the speech recognition apparatus 100 and the modeling apparatus 200 for speech recognition will be described with reference to FIGS. 1 and 2, noting that the below aspects may be implemented through other apparatus(es) or system(s).

The speech recognition modeling apparatus 200 collects training data to train a converter 310 and a standard acoustic model 330. Referring to FIG. 3, the modeling apparatus 200 may collect standard speech signals of a specific sentence as the training data, wherein the standard speech signals are generated e.g., by TTS, based on user's real speech signals, which are produced by the user verbally reading a sentence. The collected training data is input to the converter 310, and the modeling apparatus 200 trains the converter 310 using the user speech signal and the standard speech signal that corresponds to said user speech signal as training data.

For example, the modeling apparatus 200 may train the converter 310 by segmenting the input user speech signal and the corresponding standard speech signal into a plurality of frames, extracting k-dimensional feature vectors from each frame, and matching the extracted feature vectors of the user speech signal with feature vectors of the standard speech signal. The user's feature information resulting from the training of the converter 310 may be input to the standard acoustic model 330.

The modeling apparatus 200 may train the acoustic model based on a neural network (NN), and use the standard speech signal as training data, and hence the trained acoustic model may be referred to as a standard acoustic model 330. Generally, in the acoustic model, the training data that is selected may play a decisive role in increasing the accuracy and recognition rate of the acoustic model. The standard acoustic model 330 built by the modeling apparatus 200 may provide standards and achieve versatility and computability.

According to one or more embodiments, once the user's feature information is created or converted by the converter, the modeling apparatus 200 may build a targeted standard acoustic model 330 by storing or characterizing the user's feature information in the standard acoustic model 300. In this case, the standard acoustic model is personalized and substantially optimized to each target user/group, thereby achieving suitability for each target.

According to one or more embodiments, if the real/actual speech signals are obtained or captured from not only one user, but from a specific group of users or a sample group using the same language and the collected user speech signals are converted into standard speech signals and collected as training data, the modeling apparatus 200 may be able to establish the standard acoustic model 330 targeted to a target domain. By using the targeted standard acoustic model 330 that represents the user's feature information, it is possible to increase the accuracy of speech recognition and the speech recognition rate.

FIG. 4 is a diagram illustrating an example of a setting of parameters of a converter using the speech recognition modeling apparatus according to one or more embodiments. Referring back to FIG. 2, the modeling apparatus 200 may extract feature vectors from the speech signal. For example, the modeling apparatus 200 may segment a received speech signal into a plurality of frames, represent each frame using the mel-scale spectrum, and extract k-dimensional MFCC feature vectors from each frame.

According to one or more embodiments, the modeling apparatus 200 may extract feature vectors from both the user's real speech signal and a standard speech signal that corresponds to the text of the user's real speech signal. For example, under the assumption that a one-second length signal is segmented into 100 frames, a user speech signal of about 3-second length may be segmented into 300 frames. 13-dimensional feature vectors may be extracted from each of the 300 frames. In addition, the standard speech signal, such as generated by a TTS engine, that corresponds to the user speech signal may have a different format from that of the user speech signal. For example, the generated standard speech signal may be generated as a speech signal of about 3-second length, where feature vectors of such a standard speech signal may be 12-dimensional feature vectors of 300 frames.

Referring to FIG. 4, a conversion model or algorithm may be represented by a function of f(x;w). Where x denotes an input of the function and may be an input 420 from the user which may, for example have 300 frames and be of 13-dimension. w is a parameter 410 that determines or identifies the particular function used, and it may be obtained from a TTS format 430 and the user's input 420. In FIG. 4, the TTS format 430 may have, for example: 300 frames and be of 12-dimension.

Here, the modeling apparatus 200 may determine the parameter w that enables the converter to reach substantially optimal performance. For example, the modeling apparatus may define a distance dist(y, z) between a feature vector of the user speech signal and a corresponding feature vector of the standard speech signal. According to one or more embodiments, the modeling apparatus 200 may determine that a particular parameter w which minimizes the defined distance dist(y,f(x,w)) between vectors is a parameter that enables the substantially optimal performance.

For example, as y and z are vectors, a distance dist(y, z) between y and z may be calculated using Euclidean distance, Euclidean norm, or other suitable measures. The distance dist(y, z) between y and z may be calculated using different methods other than the aforesaid examples. After calculation of the distance between y and z, a parameter that minimizes the defined distance between the vectors may be determined as a substantially optimal parameter. In one or more embodiments of FIG. 4, parameter w may be determined as a matrix of 12*13, and, where the total number of parameters becomes 12*13=146. That is, once about 146 parameters are found, it is possible to convert the user speech signal into a format of the standard speech signal. Alternatively, in one or more embodiments, once a roughly approximate or suitable parameter is found which provides acceptable optimization based on the speed/quality tradeoff, that parameter may be employed and refined through later iterations.

In one or more embodiments, the speech recognition modeling apparatus 200 may collect or capture a relatively large quantity of speech signals from the user, e.g. at one time or at different times, and train the converter by setting parameters based on the user speech signal and the standard speech signal that corresponds to the user speech signal.

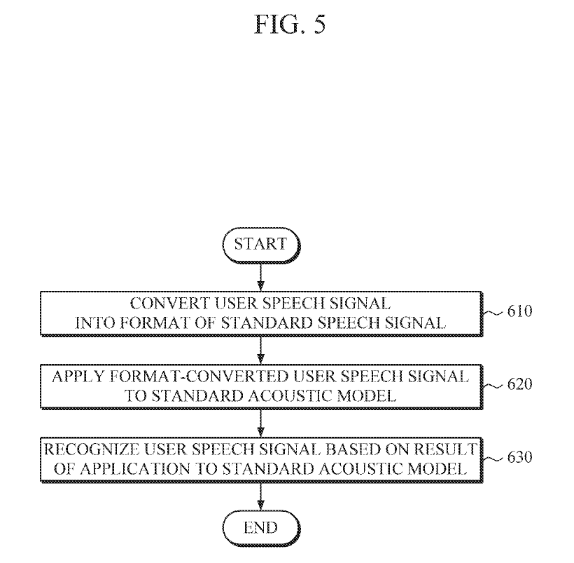

FIG. 5 is a flowchart illustrating a speech recognition method according to one or more embodiments. Below, operations of FIG. 5 will be explained through reference to FIGS. 1 and 2, noting that embodiments are not limited thereto.

Referring to FIG. 5 and FIG. 1, in one or more embodiments, the speech recognition apparatus 100 may convert a user speech signal into a format of a standard speech signal, as depicted in 610. The format of the standard speech signal may be a format of a speech signal that is produced using TTS. The standard speech signal may be obtained or generated before or after capturing, receipt, or conversion of the user speech signal.

For example, the speech recognition apparatus 100 may segment the user speech signal, which is input to the converter, into a plurality of frames, extract k-dimensional feature vectors from each of the frames, and convert the format of the extracted feature vector into a format of the standard speech signal. At this time, the standard speech signal format may be in the form of a mel-scale frequency cepstral coefficient (MFCC) feature vector or a filter bank. For example, the speech recognition apparatus 100 may segment the user speech signal into a plurality of frames, and extract k-dimensional MFCC feature vectors from each of the frames based on mel-scale spectrum that is related to a detected frequency or actually measured frequency.

The speech recognition apparatus 100 may extract feature vectors from the user speech signal which is input to the converter and convert the extracted feature vectors into a vector format of the standard speech signal, thereby converting the user speech signal into a speech signal to be applied to a standard acoustic model. In this case, the format of this speech signal is in the form of an MFCC feature vector or a filter bank and may contain the number of frames and information regarding the dimension. For example, under the assumption that MFCC features are extracted, the format of feature vectors may have k-dimension (e.g., k is 12, 13, 26, 39, or the like). In addition, 40- or higher-dimension filter bank features may be extracted.

In addition, the format of feature vectors may be designed to contain a time difference and a difference of time difference. Here, the time difference may be v₍ₜ₎−v₍ₜ₋₁₎, and the difference of time difference may be expressed as (v₍ₜ₊₁₎−v₍ₜ₎)−(v₍ₜ₎−v₍ₜ₋₁₎). In this case, the dimension of features may be increased by, e.g. non-zero integer multiples, or by other suitable measures, as would be known to one of skill in the art after gaining a thorough understanding of the present disclosure.

As the format of feature vectors may vary, the detailed description of the format of feature vectors should not be limited to the above examples.

In 620, the speech recognition apparatus 100 applies the produced speech signal to the standard acoustic model. The standard acoustic model may be an acoustic model based on at least one of GMM, hidden Markov model HMM, and an NN. The speech recognition apparatus 100 may also include the training data collector 210, the trainer 220, and the model builder 230.

Thus, the standard acoustic model may be a targeted standard acoustic model that is trained beforehand to reflect the user's feature information. For example, once the speech recognition apparatus 100 has learned the targeted standard acoustic model well enough to sufficiently reflect the user's characteristic information, speech recognition rate and accuracy may be increased. As reflecting the user's language habits, intonation, tone of speech, frequently used words, and usage of dialect, the targeted standard acoustic model may be customized and optimized for each user.

Thereafter, in 630, the speech recognition apparatus 100 recognizes the user speech signal based on the result of application to the standard acoustic model. For example, in an embodiment, the speech recognition apparatus is an electronic device, such as, a smart device such as a smart-watch, heads-up display, phone, and/or server, that performs additional operations or services depending upon what commands or queries are recognized from the user's speech signal, such as informative searching, application execution, meeting scheduling, transcription and delivery of electronic mail or messaging, as only examples.

The current embodiments may be implemented as computer readable codes in a non-transitory computer readable recording medium. Codes and code segments constituting the computer program may be inferred by a skilled computer programmer in the art after gaining a thorough understanding of the present disclosure. The computer readable recording medium includes all types of recording media in which computer readable data are stored. Examples of the computer readable record medium include a ROM, a RAM, a CD-ROM, a magnetic tape, a floppy disk, and an optical data storage. In addition, the computer readable record medium may be distributed to computer systems over a network, in which computer readable codes may be stored and executed in a distributed manner.

The approaches illustrated in any of FIGS. 3-5 that perform any of the operations described herein may, according to one or more embodiments, be performed by a specially programmed processor or a computer in conjunction with other specialized hardware such as a microphone, voice-coil, acoustic-to-electric transducer or sensor, as described above executing instructions or software to perform the operations described herein.

Instructions or software to control a processor or computer to implement the hardware components and perform the methods as described above may be written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art, after gaining a thorough understanding of the present disclosure, can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMS, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art, having gained an understanding of the present disclosure, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A speech recognition apparatus, comprising:
a converter configured to convert a captured user speech signal into a standardized speech signal format;
one or more processing devices configured to:
apply the standardized speech signal to an acoustic model; and
recognize the user speech signal based on a result of application to the acoustic model.

2. The speech recognition apparatus of claim 1, wherein the format of the standardized speech signal includes a format of a speech signal that is generated using text-to-speech (TTS).

3. The speech recognition apparatus of claim 1, wherein the converter includes at least one of the following neural network models: autoencoder, deep autoencoder, denoising autoencoder, recurrent autoencoder, and a restricted Boltzmann machine (RBM) to convert the captured user speech signal into the standardized speech signal format.

4. The speech recognition apparatus of claim 1, wherein the converter is further configured to segment the user speech signal into a plurality of frames, extract k-dimensional feature vectors from each of the frames, and convert the extracted feature vectors into the standardized speech signal format.

5. The speech recognition apparatus of claim 4, wherein the standardized speech signal format includes at least one form of a mel-scale frequency cepstral coefficient (MFCC) feature vector and a filter bank, and contains either or both of the number of frames and information regarding a dimension.

6. The speech recognition apparatus of claim 1, wherein the acoustic model is includes at least one of Gaussian mixture model (GMM), hidden Markov model (HMM), and a neural network (NN).

7. The speech recognition apparatus of claim 1, further comprising:
a training data collector configured to collect training data based on a synthetically generated standardized speech signal;
a trainer configured to train at least one of the converter or the acoustic model using the training data; and
a model builder configured to build the acoustic model based on a result of training based on the standardized speech signal.

8. A speech recognition apparatus, comprising:
a training data collector configured to collect training data based on a generated standardized speech signal;
a trainer configured to train at least one of a converter or an acoustic model using the training data; and
a model builder configured to build at least one of the converter or the acoustic model based on a result of training.

9. The speech recognition apparatus of claim 8, wherein the standardized speech signal comprises either or both of a speech signal that is generated using text-to-speech (TTS) and a speech signal that is converted from the user speech signal using the converter.

10. The speech recognition apparatus of claim 9, wherein the training data collector is further configured to generate a synthesized speech by analyzing an electronic dictionary and grammatical rules by use of the TTS.

11. The speech recognition apparatus of claim 8, wherein the training data collector is further configured to collect a standardized speech signal that substantially corresponds to the user speech signal, as the training data.

12. The speech recognition apparatus of claim 11, wherein the standardized speech signal that substantially corresponds to the user speech signal is a speech signal generated from a substantially same text as represented in the user speech signal, by use of TTS.

13. The speech recognition apparatus of claim 8, wherein the training data collector is further configured to receive a feedback from a user regarding a sentence, which is produced based on a speech recognition result, and to collect a standardized speech signal generated from feedback by the user, as the training data.

14. The speech recognition apparatus of claim 8, wherein the converter is based on at least one of the following neural network models: autoencoder, deep autoencoder, denoising autoencoder, recurrent autoencoder, and a restricted Boltzmann machine (RBM).

15. The speech recognition apparatus of claim 11, wherein the trainer is further configured to train the converter such that a distance between a feature vector of the user speech signal and a feature vector of the standard speech signal can be minimized.

16. The speech recognition apparatus of claim 15, wherein the trainer is further configured to calculate the distance between the feature vectors based on at least one of distance calculation methods including a Euclidean distance method.

17. The speech recognition apparatus of claim 8, wherein the acoustic model is at least one of Gaussian mixture model (GMM), hidden Markov model (HMM), and a neural network (NN).

18. The speech recognition apparatus of claim 8, further comprising:
a converter configured to convert a collected user speech signal into the standardized speech signal;
an acoustic model applier configured to apply the standardized speech signal to the acoustic model; and
an interpreter configured to recognize the user speech signal based on a result of application to the acoustic model.

19. A speech recognition method, comprising:
converting a user speech signal into a format of a standardized speech signal;
applying the standardized speech signal to an acoustic model; and
recognizing the user speech signal based on a result of application to the acoustic model.

20. The speech recognition method of claim 19, wherein the converting is based on at least one of the following neural network models: autoencoder, deep autoencoder, denoising autoencoder, recurrent autoencoder, and a restricted Boltzmann machine (RBM).

21. The speech recognition method of claim 19, wherein the converting of the user speech signal comprises segmenting the user speech signal into a plurality of frames, extracting k-dimensional feature vectors from each of the frames, and converting the extracted feature vectors into a format of the standardized speech signal.

22. The speech recognition method of claim 21, wherein the format of the standardized speech signal includes at least one form of a mel-scale frequency cepstral coefficient (MFCC) feature vector and a filter bank and contains either or both the number of frames and information regarding a dimension.

23. A speech recognition method, comprising:
receiving a user speech sample of a training phrase;
generating a synthesized baseline speech sample of the training phrase;
transforming one or more of the user speech sample and the baseline speech sample into a standardized format for provision to a speech model; and,
generating a speech model for the user based on the comparison of the user speech sample and the baseline speech sample.

24. The speech recognition method of claim 23, further comprising:
actuating a microphone and a processor portion to record the user speech sample; and,
actuating the processor portion to execute a text-to-speech (TTS) engine to generate the baseline speech sample of the training phrase.

25. The speech recognition method of claim 23, further comprising:
actuating a microphone and a processor portion to record user speech; and,
actuating the processor portion to recognize the user speech based on the generated speech model.

26. The speech recognition method of claim 25, further comprising:
controlling an electronic device based on the recognized user's speech.
